(19) United States
(12) Patent Application Publication
(10) Pub. No.: US 2007/0181086 A1
(43) Pub. Date: Aug. 9, 2007

(54) Assembled camshaft with camshaft setting device

(75) Inventors: Jochen Asbeck, Attendorn (DE); Michael Schebitz, Attendorn (DE)

Correspondence Address: SUGHRUE MION, PLLC, 2100 PENNSYLVANIA AVENUE, N.W., SUITE 800, WASHINGTON, DC, 20037, US

(73) Assignee: MUHR UND BENDER KG

(21) Appl. No.: 10/897,118

(22) Filed: Jul. 23, 2004

(30) Foreign Application Priority Data
Jul. 24, 2003 (DE) 10333850.0

(51) Int. Cl. F01L 1/04; B23P 17/00

(52) U.S. Cl. 123/90.6; 29/888.08

(57) ABSTRACT

An assembled camshaft (11) wherein at least one oil distributing sleeve (14, 26) for a camshaft setting device (15) is secured in a force-locking way to a plastically expanded portion of a shaft tube (12), wherein the oil distributing sleeve (14) includes a seat face (31) centered on the axis A of the shaft tube (12) and/or a radial contact face (32) for the camshaft setting device (15), which radial contact face (32) is aligned in a normal way relative to the axis A of the shaft tube (12).

### BACKGROUND OF THE INVENTION

The invention relates to an assembled camshaft wherein at least one oil distributing sleeve for a camshaft setting device is force-lockingly secured to a plastically expanded portion of a shaft tube, as well as to a method of securing a camshaft setting device on an assembled camshaft of the above-mentioned type.

Assembled camshafts of the type described here include a tubular shaft and cams which have been slid thereon, which are sintered or forged as individual components independently of the shaft and then fixed thereto. Different fixing methods are in use. For example, the cams are thermally shrunk on the shaft or the tubular shaft is plastically expanded in delimited axial regions to be able to secure the cams in a force-locking way on the tubular shaft. Such an expansion can take place by applying internal hydraulic pressure to the entire tubular shaft if the tubular shaft together with the cams are placed into a suitable die or by plastically expanding individual longitudinal portions if the hydraulic pressure is applied by a probe which is sealed relative to the shaft tube in individual portions inside. To an increasing extent, camshafts are provided with camshaft setting devices for setting the control times in internal combustion engines during the operation of the engine. These camshaft setting devices comprise an inner ring which is firmly connected to the driving end of the camshaft, and an outer ring which is settable relative to the former by a variable angle of rotation and carries a driving gearwheel or driving sprocket for driving the camshaft. Setting is effected hydraulically, with an oil distributing sleeve on the camshaft being used to supply two different chamber systems in the camshaft setting device with oil pressure. The oil distributing sleeve is supplied by the first camshaft bearing nearest to the camshaft setting device with oil pressure. Also, the oil distributing sleeve is integrated with a control system for loading the one or the other one of the chamber systems via two different bore and channel systems.

DE 199 55 507 C2 discloses a camshaft wherein a camshaft setting device is centered and tensioned relative to the camshaft via a central threaded connection. A threaded shank is integrally connected to the camshaft, with the cam-shaft setting device being secured by a nut on the threaded shank.

DE 199 58 629 A1 discloses a camshaft wherein a cam-shaft setting device is secured by a threaded connection to the camshaft, wherein the screw with the screw head is centrally threaded into the end of the camshaft.

Finally, DE 199 62 981 A1 proposes a camshaft setting device which is to be screwed on by a central fixing screw to the camshaft.

### SUMMARY OF THE INVENTION

It is the object of the present invention to provide a cam-shaft of said type and a method of producing the same wherein the camshaft setting device is secured in an accurate position and by simple means to the camshaft. The object is achieved by providing an assembled camshaft which is characterized in that the oil distributing sleeve comprises a seat face centered on the axis A of the shaft tube and/or a radial contact face for the camshaft setting device, which radial contact face is aligned in a normal way relative to the axis A of the shaft tube. According to a preferred embodiment, the camshaft setting device is also force-lockingly secured to a plastically expanded portion of the shaft tube. The method proposed for this purpose is characterized in that, after the at least one oil distributing sleeve has been secured to the shaft tube, a cylindrical seat face for the camshaft setting device, which is centered relative to the axis (A) of the shaft tube, and/or a contact face for the camshaft setting device, which extends in a normal way relative to the axis A of the shaft tube, are/is ground and that then the camshaft setting device is secured into contact centered relative to the axis A of the shaft tube with the at least one oil distributing sleeve on the shaft tube. In particular, it is proposed that the camshaft setting device is force-lockingly secured to the shaft tube by plastically radially expanding the shaft tube by applying internal hydraulic pressure. The means proposed here make it possible to secure the camshaft setting device on the shaft tube of the assembled shaft in the same way as the cams and the oil supplying sleeve, i.e. by plastically radially expanding the shaft tube without having to accept positional errors such as they can easily occur when radially expanding the axial end of the tubular shaft. Therefore, at the at least one oil distributing sleeve, after having been fixed, with said fixing operation possibly resulting in axial errors, a seat face and/or a contact face, are/is machined, i.e. precision-turned or ground, which seat face and/or contact face offset/offsets such errors. The camshaft setting device is placed on to said reference face, so that the drive of the camshaft can be fixed so as to extend accurately coaxially relative to the camshaft.

According to a first preferred embodiment, it is proposed that there is provided an oil distributing sleeve comprising two groups of inner longitudinal grooves which form oil channels together with the shaft tube, wherein first longitudinal grooves end in a radially open circumferential groove and second longitudinal grooves end in an axially open annular groove. More particularly, it is proposed that on both sides of the radially open circumferential groove there are formed two sealing grooves for receiving sealing elements.

According to a second embodiment, it is proposed that there are provided two oil distributing sleeves, wherein a first oil distributing sleeve comprises two groups of longitudinal grooves which form oil channels together with the shaft tube, wherein first longitudinal grooves end in a radially open circumferential groove and second longitudinal grooves end in an end face and wherein a second oil distributing groove comprises third inner longitudinal grooves which form oil channels together with the shaft tube and are connected to the second longitudinal grooves in the oil distributing sleeve and end in a further radially open circumferential groove. More particularly, it is proposed that on both sides outside the two radially open circumferential grooves (19, 29), there are formed sealing grooves (24, 25) for receiving sealing elements.

Furthermore, with reference to the first embodiment, it is proposed that an abutment ring is force-lockingly secured to the shaft tube at a distance from the oil distributing sleeve and that the shaft tube forms a camshaft bearing seat between the oil distributing sleeve and the abutment ring and that the circumferential groove and the sealing grooves are formed in a collar at the oil distributing sleeve. As far as the second embodiment is concerned, it is proposed more particularly that the second oil distributing sleeve forms a camshaft bearing seat and that the circumferential grooves and the sealing grooves are provided in a collar at the first oil distributing sleeve and in a collar at the second oil distributing sleeve.

Preferred embodiments of the invention are illustrated in the drawings and will be described below.

### BRIEF DESCRIPTION OF THE DRAWINGS

FIG. 1(a) is a cross-sectional view of an assembled camshaft with a cam-shaft setting device and an oil distributing sleeve according to a first embodiment of the invention, and FIG. 1(b) is a cross-sectional view of the assembled cam shaft taken along line 1(b) of FIG. 1(a);

FIG. 2(a) is a cross-sectional view of an assembled camshaft with a cam-shaft setting device and an oil distributing sleeve according to a second embodiment of the invention, and FIG. 2(b) is a cross-sectional view of the assembled cam shaft taken along line 2(b) of FIG. 2(a);

FIG. 3(a) is a cross-sectional view of an assembled camshaft with a cam-shaft setting device and two oil distributing sleeves according to the first embodiment of the invention, and FIG. 3(b) is a cross-sectional view of the assembled cam shaft taken along line 3(b) of FIG. 3(a); and

FIG. 4(a) is a cross-sectional view of an assembled camshaft with a cam-shaft setting device and two oil distributing sleeves according to the second embodiment of the invention, and FIG. 4(b) is a cross-sectional view of the assembled cam shaft of the first embodiment taken along line 4(b) of FIG. 4(a).

### DETAILED DESCRIPTION OF THE INVENTION

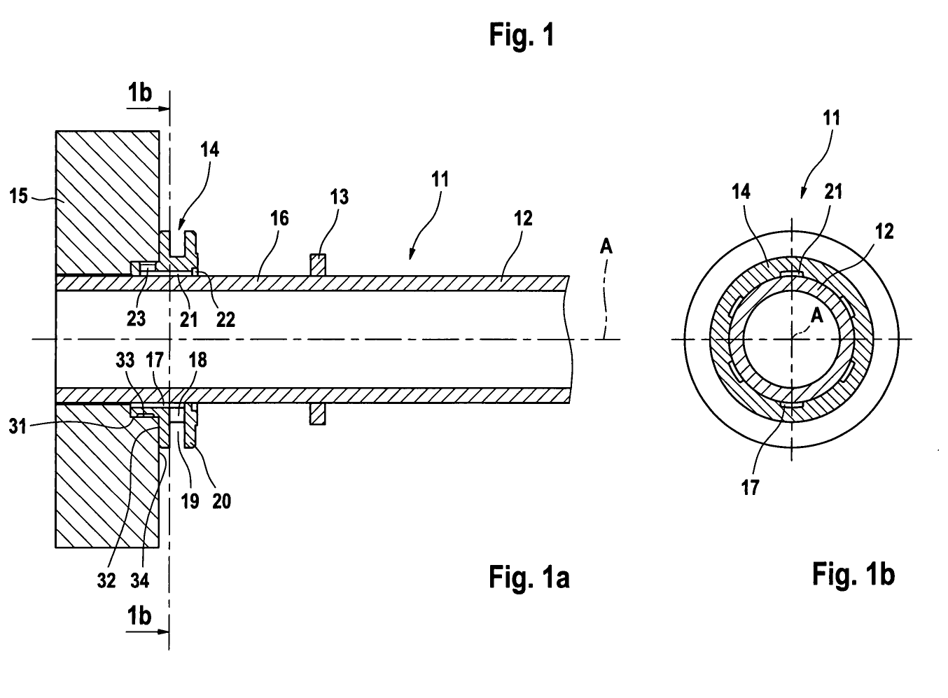

Referring to FIG. 1, the assembled camshaft 11 comprising a tubular shaft 12, an axial abutment ring 13 secured thereto, an oil distributing sleeve 14 secured thereto, and a camshaft setting device 15. The camshaft setting device is illustrated by its circumferential lines as a unit (i.e., the individual parts have not been shown). Functionally, the cam-shaft setting device includes an inner ring secured to the tubular shaft in a rotationally fast way and an outer ring which carries a gear or sprocket and which is adjustable relative to the inner ring by a limited angle of rotation. For this purpose, the camshaft setting device 15 is supplied with oil pressure via a two oil supply systems. The oil supply is effected via the oil distributing sleeve 14 which, in turn, is supplied with oil pressure by a camshaft bearing. Between the abutment ring 13 and the distributing sleeve 14, the tubular shaft 12 is provided with a bearing seat 16 which is supported in a camshaft bearing which is supplied with oil via the oil distributing sleeve 14. First inner longitudinal grooves 17 in the oil distributing sleeve 14 are connected via radial bores 18 to a radially open circumferential groove 19 which is overlapped by a camshaft bearing in such a way that oil pressure can be applied to the longitudinal grooves 17 via the circumferential groove 19. The oil pressure axially moves from the longitudinal grooves 17 into the camshaft setting device. The circumferential groove 19 is provided in a collar 20. Second inner longitudinal grooves 21 in the oil distributing sleeve 14 are connected to an axial open annular groove 22 which is covered by the camshaft bearing in such a way that oil pressure can be supplied to the longitudinal grooves 21 via the annular groove 22, with the oil pressure passing via radial bores 23 in the camshaft setting device. After the abutment ring 13 and the oil distributing sleeve 14 have been secured by radially plastically expanding the tubular shaft 12 by applying internal hydraulic pressure, there are ground, on the oil distributing sleeve 14, a cylindrical seat face 31 and an axis-normal end face 32 which are aligned coaxially and, respectively in an axis-normal way, relative to the longitudinal axis A of the camshaft. This is achieved by clamping in the camshaft along a large part of its length for the purpose of carrying out the grinding operation. In this way it is possible to compensate for distortion and axial offset of the oil distributing sleeve 14 relative to the tubular shaft 12. The camshaft setting device which has been brought into contact with the seat face 31 and the end face 32 and which comprises a corresponding bore 33 and a corresponding contact face 34 is thus accurately aligned. Only when the camshaft setting device 15 is centered relative to the oil distributing sleeve and in contact therewith, is the end of the tubular shaft 12 also plastically radially expanded to an axially limited extent by applying hydraulic internal pressure, so that the camshaft setting device 15 is connected to the tubular shaft 12 by the same fixing technology as the remaining components, more particularly the cams (not shown here).

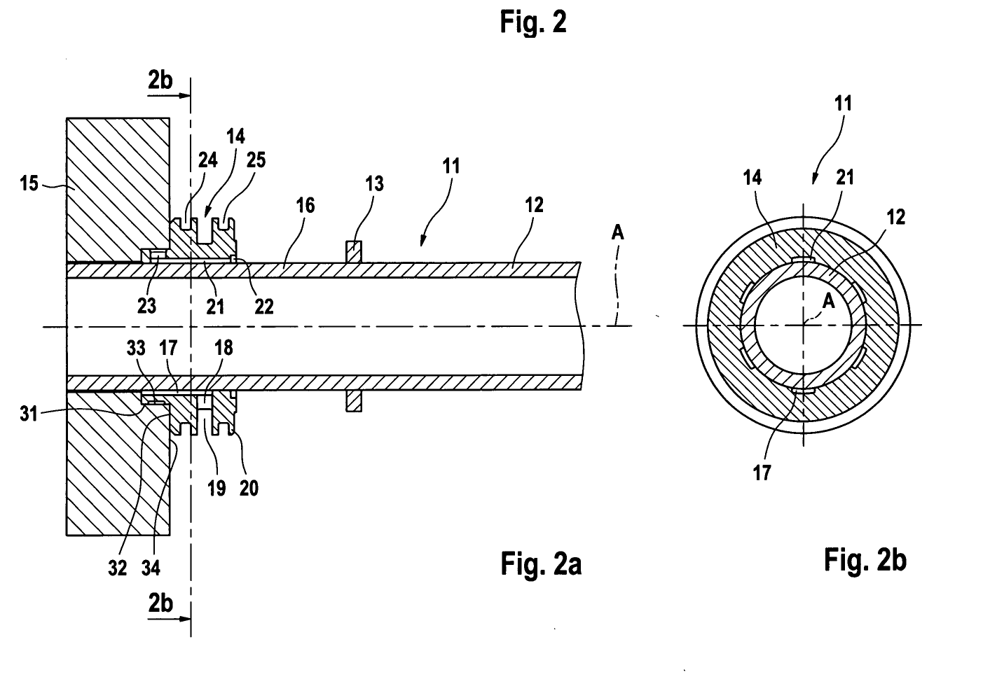

In FIG. 2, details identical to those shown in FIG. 1 have been given the same reference numbers. To that extent reference is made to the previous description. On both sides of the radially open circumferential groove 19 there are provided sealing grooves 24, 25 which are provided for receiving sealing elements, more particularly hook-type sealing rings by means of which the rotating oil distributing sleeve is sealed relative to the stationary camshaft bearing which extends over the oil distributing sleeve 14. The sealing grooves 24, 25 are also provided in the collar 20.

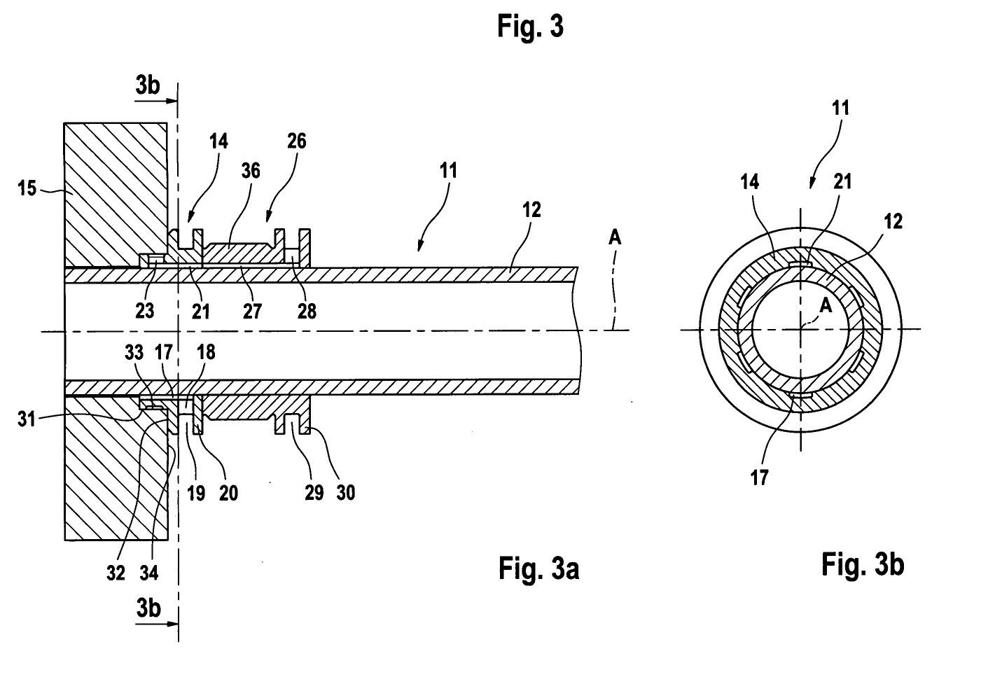

In FIG. 3, details identical to those shown in FIG. 1 have been given the same reference numbers. To that extent, reference is made to the description of FIG. 1. FIG. 3 deviates from FIG. 1 in that the oil distributing sleeve 14 does not comprise an end annular groove 23 which connects the second longitudinal grooves 21 to one another. A second oil distributing sleeve 26 comprising third inner longitudinal grooves 27 adjoining the first longitudinal grooves 17 of the first oil distributing sleeve 14 are attached to the first oil distributing sleeve 14. The third annular grooves 17 end in radial bores 28 which end in a radially open circumferential groove 29. The circumferential groove 29 is formed in a collar 30. Between the collar 20 of the first oil distributing sleeve 14 and the collar 30 of the second oil distributing groove 26, there is formed, on the latter, a bearing seat 36 for the cam-shaft bearing. The fixed camshaft bearing extends over the rotating distributing sleeve in such a way that the circumferential grooves 19 and 29 are supplied with oil and are sealed.

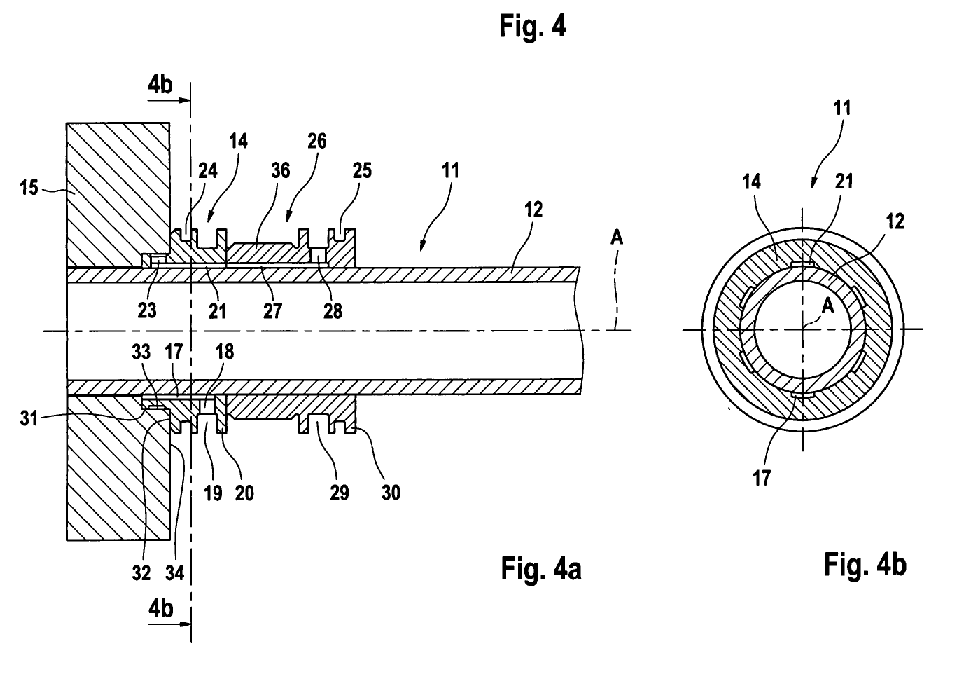

In FIG. 4, details identical to those shown in FIG. 3 have been given the same reference numbers. To that extent, reference is made to the description of FIG. 3. In addition to the characteristics of FIG. 3, the collar 20 of the first oil distributing groove 14 is provided with a sealing groove 24, whereas in the collar 30 of the second oil distributing groove 26 there is arranged a second sealing groove 25. In this case, too, the fixed camshaft bearing extends over the two oil distributing sleeves in such a way that the two circumferential grooves 19, 29 are supplied with pressurized oil.

What is claimed is:

1. An assembled camshaft (11), comprising:
a shaft tube (12) including a plastically expanded portion;
a camshaft setting device (15) secured to the shaft tube (12);
at least one oil distributing sleeve (14, 26) for the camshaft setting device (15) and secured to the plastically expanded portion of the shaft tube (12), wherein the oil distributing sleeve (14, 26) includes one of a seat face (31) centered on the longitudinal axis (A) of the shaft tube (12) and a radial contact face (32), for the camshaft setting device (15), which radial contact face (32) is aligned axis-normal relative to the longitudinal axis (A) of the shaft tube (12).

2. A camshaft according to claim 1, wherein the at least one oil distributing sleeve (14, 26) is force-lockingly secured to the plastically expanded portion of the shaft tube (12).

3. A camshaft according to claim 1, wherein the camshaft setting device (15) is also force-lockingly secured to a plastically expanded portion of the shaft tube (12).

4. A camshaft according to claim 1, wherein there is provided an oil distributing sleeve (14) comprising two groups of inner longitudinal grooves (17, 21) which form oil channels together with the shaft tube (12), wherein first longitudinal grooves (17) end in a radially open circumferential groove (19) and second longitudinal grooves (21) end in an axially open annular groove (22).

5. A camshaft according to claim 4, wherein on both sides of the radially open circumferential groove (19), there are formed two sealing grooves (24, 25) for receiving sealing elements (FIG. 2).

6. A camshaft according to claim 1, wherein there are provided two oil distributing sleeves (14, 26), wherein a first oil distributing sleeve (14) comprises two groups of longitudinal grooves (17, 21) which form oil channels together with the shaft tube (12), wherein first longitudinal grooves (17) end in a radially open circumferential groove (19) and second longitudinal grooves (21) end in an end face and wherein a second oil distributing groove (26) comprises third inner longitudinal grooves (27) which form oil channels together with the shaft tube (12) and are connected to the second longitudinal grooves (21) in the oil distributing sleeve and end in a further radially open circumferential groove (29). (FIG. 3).

7. A camshaft according to claim 6, wherein on both sides outside the two radially open circumferential grooves (19, 29), there are formed sealing grooves (24, 25) for receiving sealing elements. (FIG. 4).

8. A camshaft according to claim 4, wherein an abutment ring (13) is force-lockingly secured to the shaft tube (12) at a distance from the oil distributing sleeve (14) and that the shaft tube (12) forms a camshaft bearing seat (16) between the oil distributing sleeve (14) and the abutment ring (13).

9. A camshaft according to claim 6, wherein the second oil distributing sleeve (26) forms a camshaft bearing seat (36).

10. A camshaft according to claim 4, wherein the circumferential groove (19) and the sealing grooves (24, 25) are formed in a collar (20) at the oil distributing sleeve (14).

11. A camshaft according to claim 6, wherein the circumferential grooves (19, 29) and the sealing grooves (24, 25) are formed in a collar (20) at the first oil distributing sleeve (14) and in a collar (30) at the second oil distributing groove (26).

12. A method of producing an assembled camshaft (11), comprising the following steps:
providing a camshaft setting device (15) on a shaft tube (12) such that the camshaft setting device is centered relative to the longitudinal axis (A) of the shaft tube;
securing at least one oil distributing sleeve (14, 26) for the cam-shaft setting device (15) to a plastically expanded portion of the shaft tube (12);
machining at least one of a cylindrical seat face (31) and a contact face (34), for the camshaft setting device, which extends in a normal direction relative to the longitudinal axis (A) of the shaft tube (12) on said oil distributing sleeve (14, 26); and
securing the camshaft setting device (15) into contact with the at least one oil distributing sleeve (14, 26) on the shaft tube (12).

13. A method according to claim 12, wherein the step of securing the camshaft setting device comprises the step of plastically radially expanding the shaft tube (12) by applying internal hydraulic pressure at a portion where the camshaft setting device is located.

14. A method according to claim 12, wherein the at least one oil distributing sleeve (14, 26) is force-lockingly secured to the plastically expanded portion of the shaft tube (12).

15. A method according to claim 14, wherein the camshaft setting device (15) is force-lockingly secured to the plastically expanded portion of the shaft tube (12).
